(19) United States
(12) Patent Application Publication
(10) Pub. No.: US 2011/0099606 A1
(43) Pub. Date: Apr. 28, 2011

(54) APPARATUS AND METHOD FOR CONNECTING WITH ACCESS POINT IN MOBILE TERMINAL

(75) Inventors: Jong-Mu CHOI, Gunpo-si (KR); Keum-Youn KWON, Seongnam-si (KR)

(73) Assignee: SAMSUNG ELECTRONICS CO. LTD., Suwon-si (KR)

(21) Appl. No.: 12/910,047

(22) Filed: Oct. 22, 2010

(30) Foreign Application Priority Data
Oct. 26, 2009 (KR) 10-2009-0101572

(51) Int. Cl. G06F 7/04

(52) U.S. Cl. 726/3

(57) ABSTRACT

An apparatus and a method for simplifying a connection process with an Access Point (AP) in a mobile terminal are provided. More particularly, an apparatus and a method for simplifying a connection process with a peripheral apparatus by registering in advance information regarding the peripheral apparatus that performs an AP function to search for only the registered peripheral apparatus, and for performing a security access to the peripheral apparatus without a separate operation in a mobile terminal are provided. The mobile terminal includes an AP searching unit. The AP searching unit stores and registers information regarding APs to be connected, and searches for only the registered APs to perform a security access.

### PRIORITY

This application claims the benefit under 35 U.S.C. §119(a) of a Korean patent application filed on Oct. 26, 2009 in the Korean Intellectual Property Office and assigned Serial No. 10-2009-0101572, the entire disclosure of which is hereby incorporated by reference.

### BACKGROUND OF THE INVENTION

1. Field of the Invention

The present invention relates to an apparatus and a method for simplifying a connection process with an Access Point (AP) in a mobile terminal. More particularly, the present invention relates to an apparatus and a method for simplifying a connection process with a peripheral apparatus by registering in advance information regarding the peripheral apparatus that performs an AP function to search for only the registered peripheral apparatus, and for performing a security access to the peripheral apparatus without a separate operation in a mobile terminal.

2. Description of the Related Art

Recently, a mobile terminal is a necessity indispensable to modern people and is widely used regardless of age or sex, and service providers and terminal manufacturers competitively develop products and services for differentiation from other companies.

For example, the mobile terminal has developed to a multimedia apparatus that can provide various services, such as a phonebook, games, a Short Message Service (SMS), an Electronic (E)-mail, a morning call, a Motion Picture Expert Group Audio Layer-3 (MP3) player, a schedule management function, a digital camera, a multimedia message, a wireless Internet service, and the like.

To use a packet data service including a wireless Internet in the mobile terminal, a user needs to connect with an AP of a relevant service.

That is, the mobile terminal uses a packet data service by transmitting data to an AP. Under an environment where the AP does not exist, the mobile terminal cannot use the packet data service. Accordingly, the mobile terminal connects with the AP in order to use the packet data service.

To connect with the AP safely and easily, a Wi-Fi Protected Setup (WPS) method is used recently.

The WPS method activates an AP and a mobile terminal, and selects a menu of the mobile terminal to perform a scan operation, thereby searching for an AP that allows WPS.

In case of searching for the AP that allows WPS through the above scan process, specific buttons (WPS push) of the AP and the mobile terminal are input to obtain AP connection information and then connection with the AP is performed.

The above method provides convenience of simply connecting to an AP without inputting separate connection information. However, since a connection process is performed under a user's control, the inconvenience that a user has to perform an operation for the connection process in person still exists.

Therefore, a need exists for a system and method for simplifying a connection process with an AP in a mobile terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for simplifying a connection process with a peripheral apparatus that performs an AP function in a mobile terminal.

Another aspect of the present invention is to provide an apparatus and a method for reducing a connection process by searching for only a registered peripheral apparatus in a mobile terminal.

Still another aspect of the present invention is to provide an apparatus and a method for searching for only a registered peripheral apparatus and for automatically connecting to a relevant peripheral apparatus in a mobile terminal.

In accordance with an aspect of the present invention, an apparatus for connecting to an Access Point (AP) in a mobile terminal is provided. The apparatus includes an AP searching unit for storing and registering information regarding APs to be connected, for searching for only the registered APs, and for performing a security access to a registered AP using a message requesting a security access procedure, including information regarding a mobile terminal.

In accordance with another aspect of the present invention, a method for connecting to an AP in a mobile terminal is provided. The method includes storing and registering information regarding APs to be connected, searching for only the registered APs, and transmitting an access request message including the information of the mobile terminal to perform a security access to the searched AP.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a mobile terminal that reduces a connection process with a peripheral apparatus according to an exemplary embodiment of the present invention;

FIG. 2 is a flowchart illustrating a process for connecting to a peripheral apparatus that performs an AP function in a mobile terminal according to an exemplary embodiment of the present invention;

FIG. 3 is a flowchart illustrating a process for connecting to a mobile terminal at a peripheral apparatus that performs an AP function according to an exemplary embodiment of the present invention; and

FIG. 4 is a diagram illustrating a connection process with a peripheral apparatus that performs an AP function in a mobile communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for reducing a connection process with a peripheral apparatus by searching for only a registered peripheral apparatus when searching for a peripheral apparatus that performs an AP function and exists in the neighborhood of a mobile terminal.

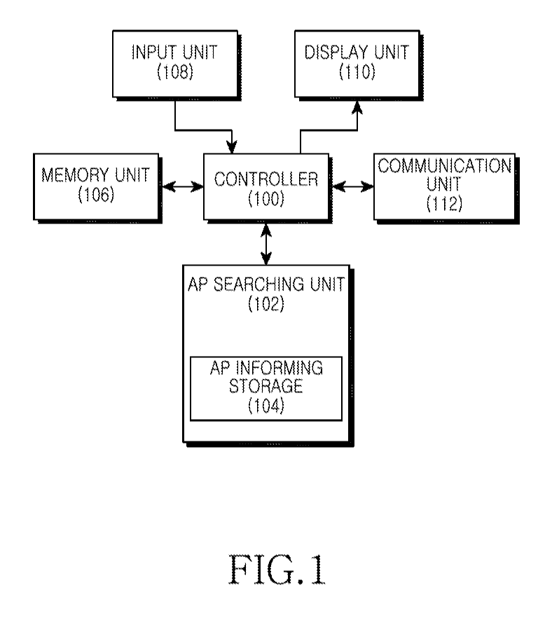

FIGS. 1 through 4, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a mobile terminal that reduces a connection process with a peripheral apparatus according to an exemplary embodiment of the present invention.

Referring to FIG. 1, the mobile terminal may include a controller 100, an AP searching unit 102, a memory unit 106, an input unit 108, a display unit 110, and a communication unit 112. The AP searching unit 102 may include an AP information storage 104. The mobile terminal may include additional units that are not illustrated here merely for the sake of clarity. Similarly, the functionality of two or more of the above units may be integrated into a single component without departing from the spirit or scope of the present invention.

The controller 100 of the mobile terminal controls an overall operation of the mobile terminal. For example, the controller 100 performs processes and controls voice communication and data communication. In addition to the general functions, according to an exemplary embodiment of the present invention, the controller 100 performs an operation for simplifying a connection process with a peripheral apparatus.

To perform the above operation, the controller 100 registers and searches for only a peripheral apparatus, and when searching for the registered peripheral apparatus, performs a security access without a separate process.

The controller 100 that searches for the peripheral apparatus stores information regarding the peripheral apparatus, that is, information that can determine the AP such as a Service Set Identifier (SSID), a Basic Service Set Identifier (BSSID), and channel information, and then periodically performs a scan process on a registered peripheral apparatus, and allows the AP searching unit 102 to perform the above process.

Additionally, when searching for a registered peripheral apparatus in advance through the scan process, the controller 100 that performs a security access incorporates information of a mobile terminal into a message requesting to perform a security access to allow the peripheral apparatus to determine whether an access to the mobile terminal is allowed.

The AP searching unit 102 searches for a registered peripheral apparatus and connects to the peripheral apparatus under control of the controller 100. That is, the AP searching unit 102 performs a scan process of searching for a registered peripheral apparatus in advance using information regarding the peripheral apparatus stored in the AP information storage 104, and performs a security access process of automatically connecting to the searched peripheral apparatus. In addition, the AP information storage 104 stores information regarding the peripheral apparatus, that is, information that can determine the AP such as an SSID, a BSSID, and channel information. The AP information storage 104 may be included in the memory unit 106.

The memory unit 106 may include, for example, any or all of a Read Only Memory (ROM), a Random Access Memory (RAM), a flash ROM, and the like. The ROM stores microcode (i.e., code) of programs for processing and control of the controller 100 and the AP searching unit 102, and various reference data. According to an exemplary embodiment of the present invention, the ROM may include the AP information storage 104.

The RAM serves as a working memory of the controller 100 and stores temporary data occurring during execution of various programs. In addition, the flash ROM may store various updatable data for storage such as information of a phonebook, calling messages, received messages, a user's touch input point, and the like.

The input unit 108 includes a plurality of function keys such as numerical key buttons of 0 to 9, a menu button, a cancel button, an OK button, a TALK button, an END button, an Internet access button, navigation key buttons, letter input keys, and the like. The input unit 108 provides key input data corresponding to a key pressed by a user to the controller 100. These keys are merely examples of keys which may make up the input unit 108. The input unit may include additional or different keys, or different input mechanisms through which the user supplies input to the mobile terminal.

The display unit 110 displays status information generated during an operation of the mobile terminal, a limited number of letters, a large amount of moving images and still images, and the like. The display unit 110 may be a color Liquid Crystal Display (LCD), an Active Mode Organic Light Emitting Diode (AMOLED), and the like. The display unit 110 may have a touch input device. When the display unit 110 having the touch input device is applied to a touch input type mobile terminal, the display unit 110 may serve as an input unit.

The communication unit 112 transmits/receives a Radio Frequency (RF) signal of data input/output via an antenna (not illustrated). For example, during transmission, the communication unit 112 channel-codes and spreads data to be transmitted, and performs an RF process on the signal to transmit the signal. During reception, the communication unit 112 converts a received RF signal into a baseband signal, and despreads and channel-decodes the baseband signal to recover data. The communication unit 112 includes a wireless Local Area Network (LAN) to transmit/receive information required for an AP connection.

When receiving a signal for searching for a peripheral apparatus from the mobile terminal, a peripheral apparatus (not shown) that performs an AP function communicates with the mobile terminal to transmit information of the AP to the mobile terminal. When receiving a security access request from the mobile terminal after transmitting the information of the AP, the peripheral apparatus connects to the mobile terminal. At this point, the peripheral apparatus determines information of the mobile terminal included in the security access request received from the mobile terminal to determine whether the mobile terminal is a terminal allowed to connect with the peripheral apparatus. When determining that the mobile terminal is the allowed terminal, the peripheral apparatus connects to the mobile terminal.

The function of the AP searching unit 102 may be performed by the controller 100 of the mobile terminal. The separate configuration and illustration of the AP searching unit 102 are for convenience in description only, and are not for limiting the scope of the present invention. That is, it would be obvious to those skilled in the art that various modifications may be made within the scope of the present invention. For example, all of the functions of the AP searching unit 102 may be processed by the controller 100.

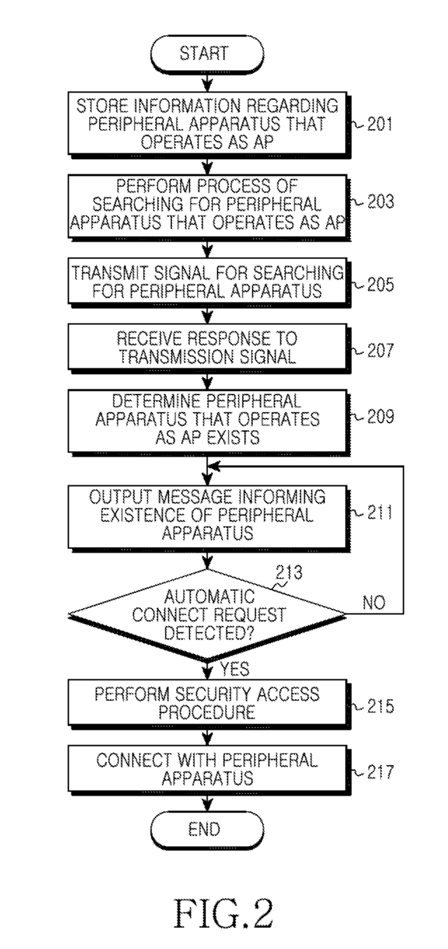

FIG. 2 is a flowchart illustrating a process for connecting to a peripheral apparatus that performs an AP function in a mobile terminal according to an exemplary embodiment of the present invention.

Referring to FIG. 2, the mobile terminal stores and registers information regarding a peripheral apparatus that operates as an AP in step 201. Here, the information regarding the peripheral apparatus that operates as the AP denotes information that can determine the AP, such as an SSID, a BSSID, channel information, and the like. The information regarding the peripheral apparatus that operates as the AP is stored in advance so that the information is used when the mobile terminal searches for only a registered AP.

In step 203, the mobile terminal searches for a peripheral apparatus that operates as an AP.

To perform the above searching process, the mobile terminal determines a peripheral apparatus to be searched for using the information regarding the peripheral apparatus that operates as the AP registered in advance, and transmits a signal for searching for a peripheral apparatus to the peripheral apparatus in step 205.

Here, the mobile terminal transmits a signal for searching for the peripheral apparatus, and receives a response to the signal to search for a peripheral apparatus. When receiving a signal corresponding to the peripheral apparatus, the peripheral apparatus that has received the signal transmits a response to the signal to the mobile terminal.

In step 207, the mobile terminal receives a response to the transmitted signal for searching for a peripheral apparatus. The mobile terminal determines in step 209 that a peripheral apparatus that operates as an AP exists in the neighborhood using the received response. In contrast, when the mobile terminal does not receive a response to the signal for searching for a peripheral apparatus in step 207, it determines that a peripheral apparatus that operates as an AP does not exist in the neighborhood and may re-perform the process of searching for the peripheral apparatus. That is, the mobile terminal determines in step 201 whether the peripheral apparatus exists through reception of a response transmitted from the registered peripheral apparatus.

Since the mobile terminal that performs the above operation knows in advance to search for a peripheral apparatus and performs a process of searching for only the peripheral apparatus, the mobile terminal may perform an AP search process simpler than an AP search process of the conventional mobile terminal.

In step 211, when the mobile terminal determines in advance that the registered peripheral apparatus exists in the neighborhood, it pops up a message informing that the peripheral apparatus exists. The mobile terminal then outputs information regarding the searched peripheral apparatus and a message asking whether to connect the peripheral apparatus to the mobile terminal to allow a user of the mobile terminal to select whether to perform an automatic connection process of enabling simple connection between the two apparatuses.

In step 213, the mobile terminal determines whether an automatic connect request by a user is detected.

As described above, the automatic connect request simply connects the mobile terminal and the peripheral apparatus without a separate operation. The automatic connection may be performed using a security access such as a WPS.

In step 213, if it is determined that the automatic connect request is not detected, the mobile terminal re-performs the process of step 211 and re-determines selection of a user of the mobile terminal.

In contrast, if it is determined in step 213 that the automatic connect request is detected, the mobile terminal performs a security access procedure in step 215, and connects with the peripheral apparatus in step 217.

At this point, the mobile terminal performs a security access procedure without a separate input, such as a key input, that allows connection of the two apparatuses. Additionally, the mobile terminal allows the peripheral apparatus to determine whether a terminal requesting a security access procedure is a terminal allowed to access the peripheral apparatus by incorporating information regarding the mobile terminal into a message requesting the security access procedure and transmitting the same to the peripheral apparatus.

Thereafter, the mobile terminal ends the present algorithm.

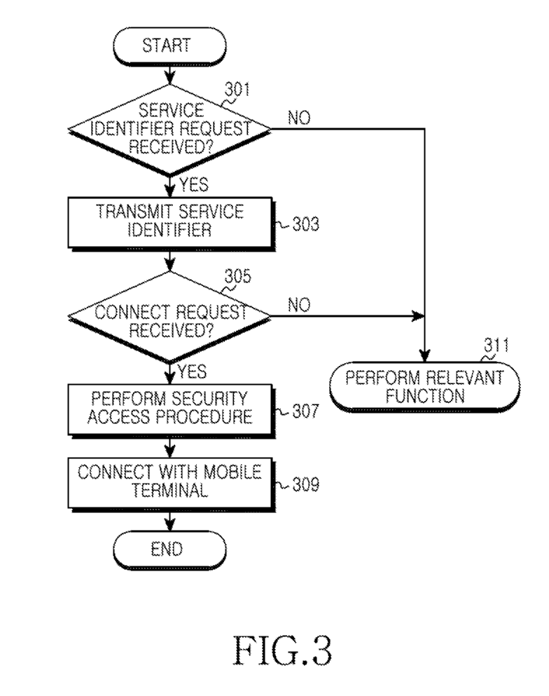

FIG. 3 is a flowchart illustrating a process for connecting to a mobile terminal at a peripheral apparatus that performs an AP function according to an exemplary embodiment of the present invention.

Referring to FIG. 3, the peripheral apparatus determines in step 301 whether a service identifier request is received. Here, the service identifier request may be an example of a signal for searching for a peripheral apparatus, which corresponds to step 205 of FIG. 2.

In step 301, if it is determined that the service identifier request is not received, the peripheral apparatus performs a relevant function (e.g., an idle mode) in step 311.

In contrast, if it is determined in step 301 that the service identifier request is received, the peripheral apparatus allows the mobile terminal that has requested the service identifier to determine that a peripheral apparatus that performs an AP function exists in the neighborhood. The service identifier is then transmitted in step 303 to the mobile terminal to determine whether the peripheral apparatus exists in the neighborhood.

In step 305, the peripheral apparatus determines whether a connection request is received from the mobile terminal. Here, the connection request received from the mobile terminal corresponds to a security access request between the mobile terminal and the peripheral apparatus.

If it is determined in step 305 that the connection request is not received from the mobile terminal, the peripheral apparatus performs a relevant function (e.g., stands by to receive a connection request) in step 311.

In contrast, if it is determined in step 305 that the connection request is received from the mobile terminal, the peripheral apparatus performs a security access procedure with the mobile terminal in step 307, and connects to the mobile terminal in step 309.

At this point, after receiving a message requesting a security access from the mobile terminal, the peripheral apparatus performs the security access procedure, and determines whether the mobile terminal is allowed to access the peripheral apparatus by determining information regarding the mobile terminal included in the message. That is, when determining that the mobile terminal is allowed to access the peripheral apparatus, the peripheral apparatus performs the security access procedure. In contrast, when determining that the mobile terminal is not allowed to access the peripheral apparatus, the peripheral apparatus does not perform the security access procedure with the mobile terminal.

Thereafter, the peripheral apparatus ends the present algorithm.

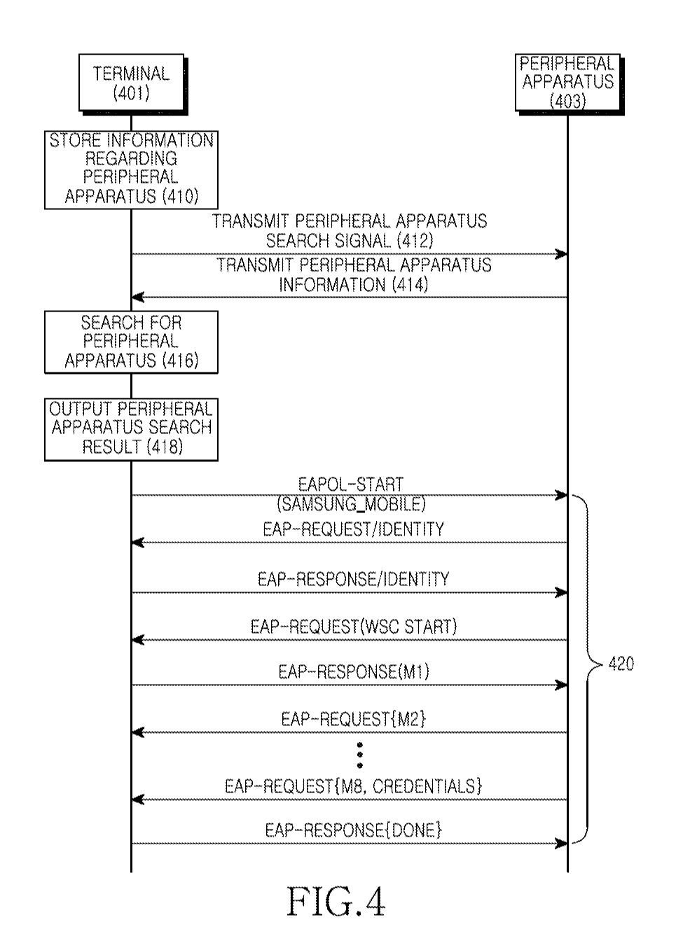

FIG. 4 is a diagram illustrating a connection process with a peripheral apparatus that performs an AP function in a mobile communication system according to an exemplary embodiment of the present invention.

Referring to FIG. 4, the mobile communication system may include a mobile terminal 401 and a peripheral apparatus 403 that performs an AP function.

In step 410, the mobile terminal 401 stores and registers information regarding a peripheral apparatus 403, which operates as an AP. Here, the information regarding the peripheral apparatus that operates as the AP denotes information that can determine the AP, such as an SSID, a BSSID, channel information, and the like. Assuming that the peripheral apparatus 403 that operates as the AP is a digital Television (TV) by Samsung Electronics Co., Ltd., the mobile terminal 401 stores information regarding the digital TV by Samsung Electronics Co., Ltd.

The mobile terminal 401 determines that the peripheral apparatus 403 to be searched for using the information regarding the peripheral apparatus 403 operates in advance as the registered AP, and transmits a signal to the peripheral apparatus 403 for searching for a peripheral apparatus in step 412. Accordingly, the peripheral apparatus 403 that has received the peripheral apparatus search signal transmits peripheral apparatus information in response to the signal in step 414.

That is, the peripheral apparatus 403 transmits a service identifier informing of the digital TV to the mobile terminal 401. When receiving the service identifier, the mobile terminal 401 determines that it has searched for the peripheral apparatus 403 existing in the neighborhood in step 416.

Thereafter, the mobile terminal 401 outputs in step 418 the peripheral apparatus searching result on a display unit to allow a user to connect with the searched peripheral apparatus 403.

When the user of the mobile terminal 401 selects to connect with the peripheral apparatus, the mobile terminal 401 requests a security access to the peripheral apparatus 403 using a WPS method as illustrated. At this point, the mobile terminal 401 incorporates information (e.g., SAMSUNG MOBILE) of the mobile terminal 401 into a message requesting the security access to allow the peripheral apparatus 403 that receives the message to determine the information of the mobile terminal 401.

For example, when the mobile terminal 401 transmits to the peripheral apparatus 403 a security access request message including information representing it is a terminal by Samsung Electronics Co., Ltd., the peripheral apparatus 403 determines the information representing the terminal by Samsung Electronics Co., Ltd. to determine whether the terminal is allowed to access the peripheral apparatus.

In step 420, the peripheral apparatus 403 performs a security access process with the mobile terminal 401.

That is, the above process may simplify a connection process between products by Samsung Electronics Co., Ltd.

As described above, exemplary embodiments of the present invention allow a mobile terminal to search for only a registered peripheral apparatus when the mobile terminal searches for a peripheral apparatus that performs an AP function existing in the neighborhood, and perform a security access to the peripheral apparatus without a separate operation, thereby reducing a connection process with the peripheral apparatus.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for connecting to an Access Point (AP) in a mobile terminal, the apparatus comprising:
an AP searching unit for
storing and registering information regarding APs to be connected, wherein the AP searching unit searches for only the registered APs, and
performing a security access to the registered AP using a message requesting a security access procedure, wherein the message comprises information regarding a mobile terminal.

2. The apparatus of claim 1, wherein the AP searching unit searches for the registered APs and then outputs the searched results.

3. The apparatus of claim 1, wherein the AP searching unit searches for only the registered APs by determining information regarding the APs stored in advance and by requesting a transmission of AP information from the registered APs.

4. The apparatus of claim 1, wherein an AP that receives an access request message determines whether a mobile terminal is allowed to access the AP by determining information of the mobile terminal included in the access request message, and connects with the allowed terminal.

5. The apparatus of claim 1, wherein the AP searching unit searches for the AP and then automatically performs a security access to the searched AP.

6. The apparatus of claim 5, wherein the AP searching unit performs the security access using a Wi-Fi Protected Setup (WPS).

7. A method for connecting to an Access Point (AP) in a mobile terminal, the method comprising:
storing and registering information regarding APs to be connected;
searching for only the registered APs; and
transmitting an access request message comprising the information of the mobile terminal to perform a security access to the searched AP.

8. The method of claim 7, further comprising:
after searching for only the registered APs, outputting the searched results.

9. The method of claim 7, wherein the searching for only the registered APs comprises:
determining information regarding APs stored in advance; and
requesting registered APs to transmit AP information using the determined information.

10. The method of claim 7, further comprising:
determining, at an AP that receives an access request message, whether the terminal is a mobile terminal allowed to access the AP by determining information of the mobile terminal included in the access request message; and
connecting with the allowed terminal.

11. The method of claim 7, wherein the security access to the searched AP is automatically performed after the AP is searched for.

12. The method of claim 11, wherein the security access to the searched AP is performed using a Wi-Fi Protected Setup (WPS).

13. The apparatus of claim 5, wherein when a manufacturer of the mobile terminal is the same as that of the AP, the AP searching unit automatically performs the security access.

14. The method of claim 11, wherein when a manufacturer of the mobile terminal is the same as that of the AP, the security access to the searched AP is automatically performed.
